(19) United States
(12) Patent Application Publication
(10) Pub. No.: US 2016/0194187 A1
(43) Pub. Date: Jul. 7, 2016

(54) Opener Device

(71) Applicants: Barbara A. Greadington, Tallahassee, FL (US); Robert E. Sharpton, Miami, FL (US)

(72) Inventors: Barbara A. Greadington, Tallahassee, FL (US); Robert E. Sharpton, Miami, FL (US)

(21) Appl. No.: 15/053,781

(22) Filed: Feb. 25, 2016

Related U.S. Application Data
(63) Continuation-in-part of application No. 13/917,268, filed on Jun. 13, 2013, now abandoned.
(60) Provisional application No. 61/658,967, filed on Jun. 13, 2012.

(51) Int. Cl. B67B 7/46

(52) U.S. Cl. CPC B67B 7/30

(57) ABSTRACT

The present invention comprises a device having two arms connected together at a first end. At the second end of the first arm the device has a gripping member. At the second end of the second arm is a slitting member. The gripping member and slitting member meet together in order to puncture and tear open a snack bag.

### CROSS-REFERENCES TO RELATED APPLICATIONS

Pursuant to the provisions of 37 C.F.R. §1.53(c), this non-provisional application is a continuation-in-part of U.S. application Ser. No. 13/917,268, filed on Jun. 13, 2013, which claims the benefit of an earlier-filed provisional patent application, U.S. Application Ser. No. 61/656,624, filed on Jun. 13, 2012. All applications list the same inventors.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of devices made for opening bags. More specifically, the invention comprises a device having two arms which assist in opening bags.

2. Description of the Related Art

Plastic bags are used for many purposes. One common purpose is to transport and store foods, such as snacks in a sealed form. Bags can be filled with snacks, such as chips, candies, pretzels and peanuts, to name a few. The bags are often closed by heat sealing or treating with adhesive chemicals. These sealing mechanisms can create a seal that is very difficult to open without the assistance of a tool, such as scissors or a knife.

Several devices exist which are specifically designed for the purpose of opening a sealed bag. For example, there are several opening devices which use a sharp edge or razor within a plastic cover. This type of device allows a bag to slide over the razor, cutting a slice through the bag. However, there are no devices which effectively puncture and grasp a bag such that the user can easily tear open the bag. Additionally, there are no devices which use a dull edge permuting use on an airplane or by young children. Therefore, what is needed is a device which allows a snack bag to be punctured, grasped and torn open with ease without the need for an exposed edge.

The present invention achieves this objective, as well as others that are explained in the following description.

### BRIEF SUMMARY OF THE INVENTION

The present invention comprises a bag opening device. The bag opening device has two arms, each having a first end and a second end. The first ends of each arm are connected together such that the arms can pivot together at the second ends of each arm. A gripping member is attached to the second end of the first arm and a slitting member is attached to the second end of the second arm. The gripping member has a surface, a raised portion and a channel. The slitting member has a surface, a crevice and a blade. The opener device can be used to open bags or other similar objects by placing the bag between the gripping member and the splitting member. As the two ends are pushed together the gripping surface of the gripping member pinches the bag into the crevice, such that the bag comes into contact with blade. The blade punctures the bag and the user can slide the device laterally across the top of the bag. The bag slides easily because it passes through an air gap in the device which is formed between surface of gripping member and surface of slitting member.

### BRIEF DESCRIPTION OF THE SEVERAL VIEWS OF THE DRAWINGS

FIG. 1 is a perspective view, showing the present invention.

FIG. 2 is a perspective view, showing an expanded view of the gripping member of the present invention.

FIG. 3 is a perspective view, showing an expanded view of the slitting member of the present invention.

FIG. 4 is a cross section view, showing the gripping member and the slitting member of the present invention as they meet together.

FIG. 5 is a perspective view, showing the present invention in use tearing through a snack bag.

FIG. 6 is a perspective view, showing the present invention in use gripping and tearing a snack bag.

FIG. 7 is a perspective view, showing an alternate embodiment of the gripping member.

FIG. 8 is a perspective view, showing an alternate embodiment of the slitting member.

FIG. 9 is a perspective view, showing the present invention.

FIG. 10 is a perspective view, showing the slitting member of the present invention.

FIG. 11 is a perspective view, showing an expanded view of the slitting member of the present invention.

FIG. 12 is a perspective view, showing the gripping member of the present invention.

FIG. 13 is a perspective view, showing an expanded view of the gripping member of the present invention.

FIG. 14 is a cross section view, showing the gripping member and the slitting member of the present invention as they meet together.

FIG. 15 is a perspective view, showing the present invention in use tearing through a snack bag.

FIG. 16 is a perspective view, showing the present invention in use gripping and opening a bottle top using the gripping surface of the present invention.

### REFERENCE NUMERALS IN THE DRAWINGS

10 device
12 first arm
13 second arm
14 slitting member
16 gripping member
18 connecting piece
20 central void
22 gripping surface
24 central prong
26 outer prong
28 bag
30 user
32 alternate gripping member
34 alternate gripping surface
38 central void
40 alternate slitting member
42 openings
44 edges
100 device
120 first arm
140 second arm
160 slitting member
180 gripping member
200 stop
220 end cap
240 end cap
260 blade
280 surface
300 raised portion
320 channel
340 crevice
360 surface
380 bag
400 cap
420 connector
440 gripping surface
460 top opener
480 gap

### DETAILED DESCRIPTION OF THE INVENTION

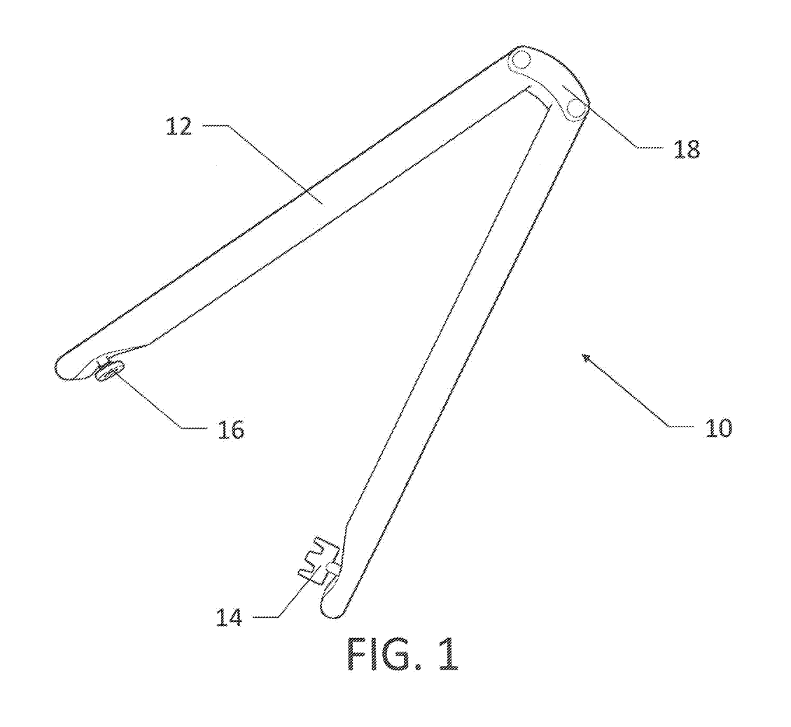

FIG. 1 illustrates the present invention. The device 10 has two arms 12, 13 that are connected together by any known means which allow first arm 12 and second arm 13 to pivot together and apart. For example, a bolt secured by a nut can be used as a pivoting means. First arm 12 and second arm 13 are designed so that the user can easily grip the device. The users hand can fit through opening 42 on each arm 12, 13 for use. Openings 42 on either arm 12, 13 assist the user in gripping and pivoting the arms into position to open a bag or a jar. FIG. 1 also illustrates a connecting piece 18 which connects a first end of first arm 12 and a first end of second arm 13 together. Connecting piece 18 can be any known device which attaches first arm 12 and second arm 13 such that the desired motion can be achieved. One example of a connecting piece 18 is a rivet which secures the first arm 12 and second arm 13.

At the second end of first arm 12 a gripping member 16 is attached. At the second end of second arm 13 a slitting member 14 is attached. Gripping member 16 and slitting member 14 meet when arms 12, 13 hinge together. As illustrated, the device can include a series of arced opening surfaces, or edges 44, for opening bottles or jars. The edges 44 are preferably serrated and located on the inside of each arm 12, 13. The bottle/jar opening surfaces, edges 44, would be arced in varying sizes which would allow the user to open bottles or jars of varying sizes. To open a bottle or jar edges 44 would be applied to the top (or lid) of a bottle or jar and the user would press the two arms 12, 13 together forming a tight partially closed circle around the top (or lid). In order to open the bottle or jar the user would turn the device and hold the bottle or jar in one place. This optional use could be added to give the present device additional functions.

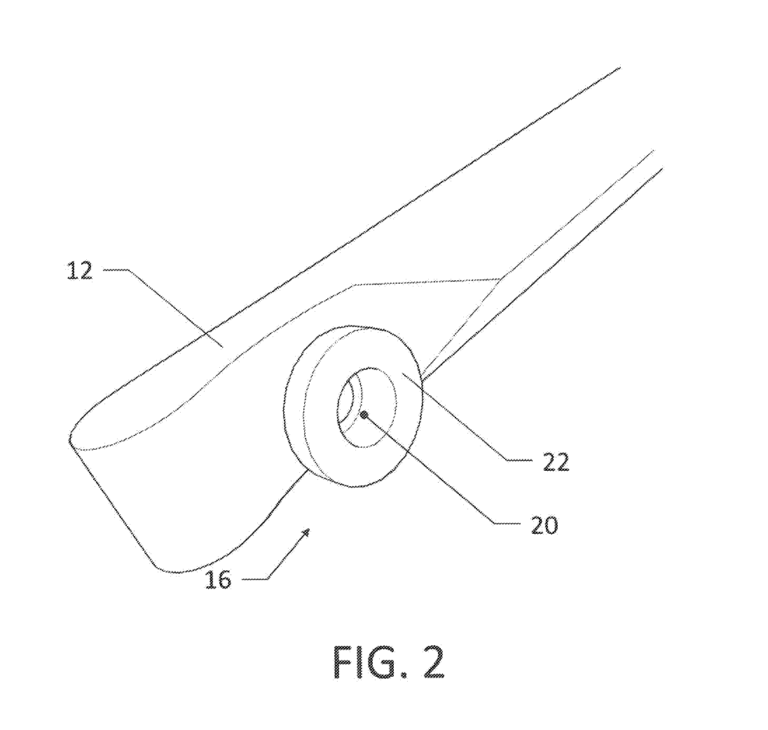

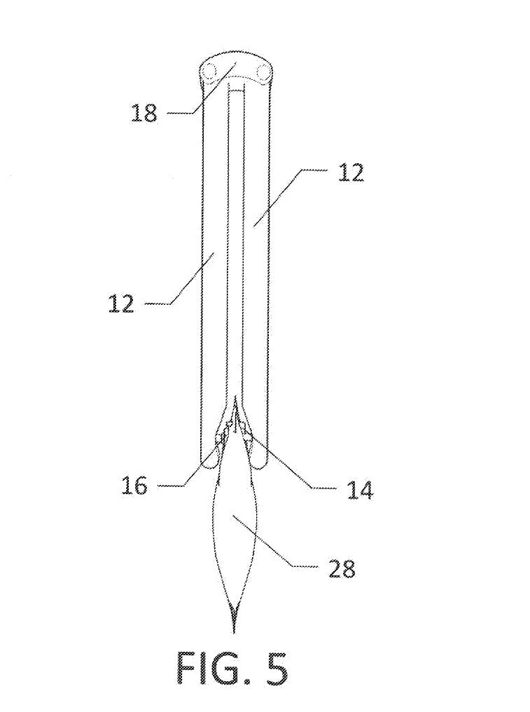

In FIG. 2, a close up view of the gripping member 16 is shown. Gripping member 16 is attached to the inside surface of first arm 12. Gripping member 16 can be attached by any method which fixes gripping member 16 in place on first arm 12. It is preferable that gripping member 16 has a central void 20. Gripping surface 22 is designed to contact bag (shown in FIG. 5) and hold the bag in place so that it can be punctured and torn.

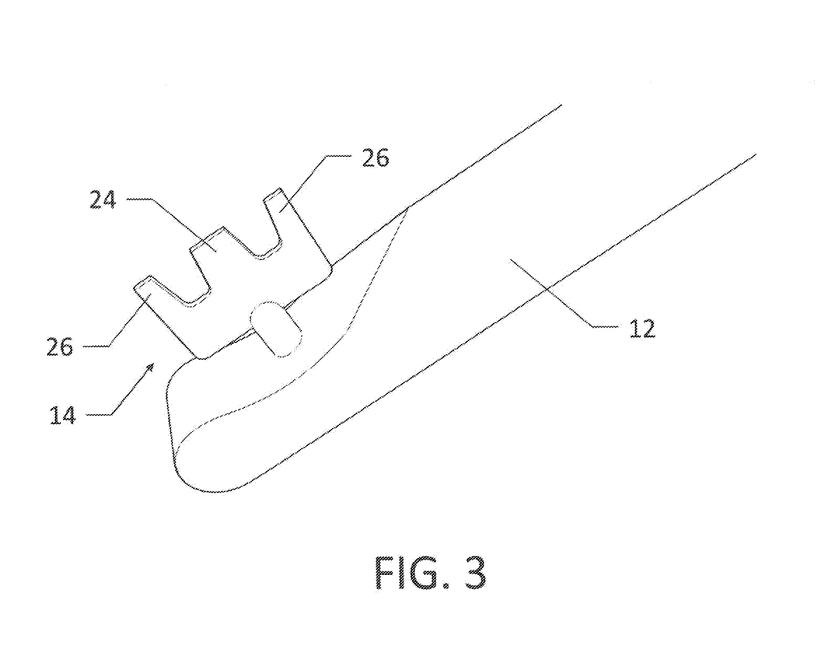

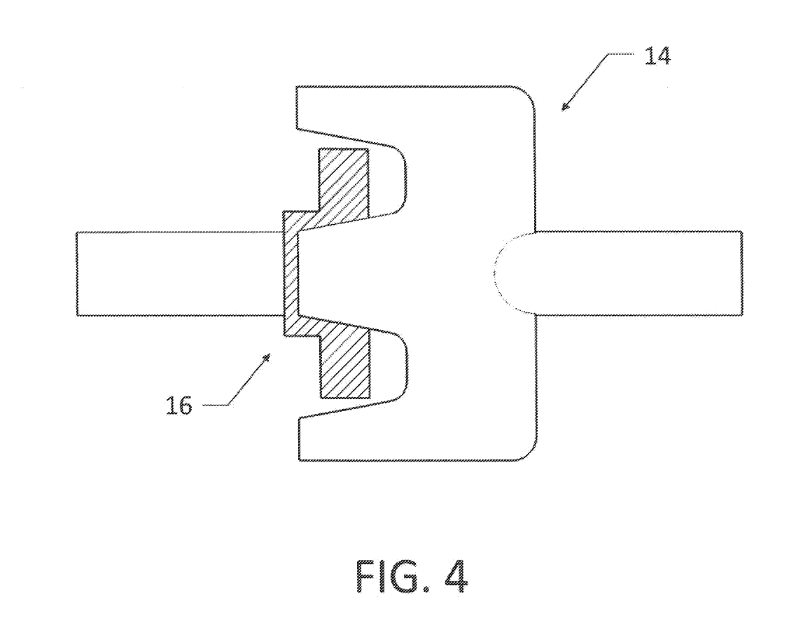

As illustrated in FIG. 3, slitting member 14 is attached to the inside surface of second arm 13. Slitting member 14 preferably has three prongs, two outer prongs 26 and one central prong 24. Slitting member 14 is preferably made of a hard plastic sharpened or narrowed at the ends of the prongs. Although the prongs could be made to be very sharp, it is preferable that the ends of prongs 24, 26 are merely narrowed to a dull point which would not he capable of cutting a user's skin. Slitting member 14 can be any shape, having at least one prong, such that the snack bag is easily punctured. In order to easily puncture the snack bag, the slitter 14 is pushed through the bag opposite an open space (central void 20), while the snack bag is held flat against the surface of the pointed slitter member 14. The central void 20 on gripping member 16 allows even a dull surface to penetrate through the snack bag which is held taut against the gripping member 16. This is more clearly illustrated in a cross section view in FIG. 4, which shows the placement of the slitter 14 opposite of the gripping member 16 when arms 12, 13 are hinged together.

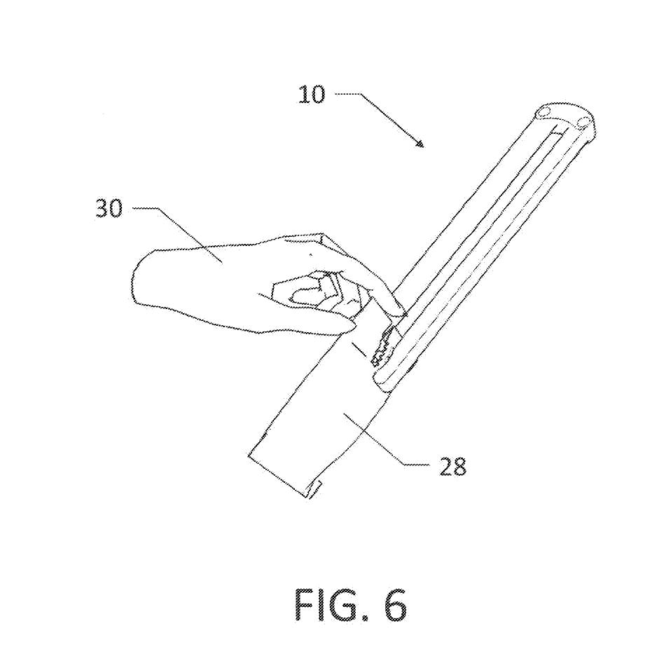

FIG. 5 shows the present invention in use. A snack bag 28 is placed between arms 12, 13 specifically between slitting member 14 and gripping member 16. The user presses arms 12, 13 toward one another (along a single plane). As the user presses arms 12, 13 together gripping member 16 grabs the bag 28 and holds it taut against gripping surface 22. As illustrated in FIG. 6, the user 30 can gently grasp bag 28 with one hand JO and device 10 with other hand (not shown) and slowly tear bag 28 in order to access the food or materials within. Gripping member 16 is capable of holding bag 28 in place, as the opening is widened by the user.

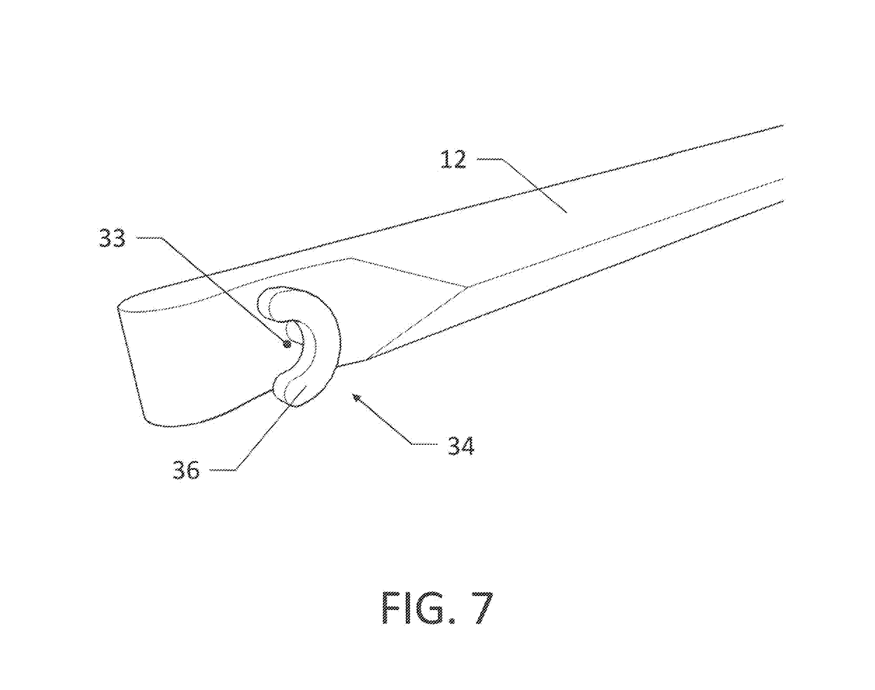

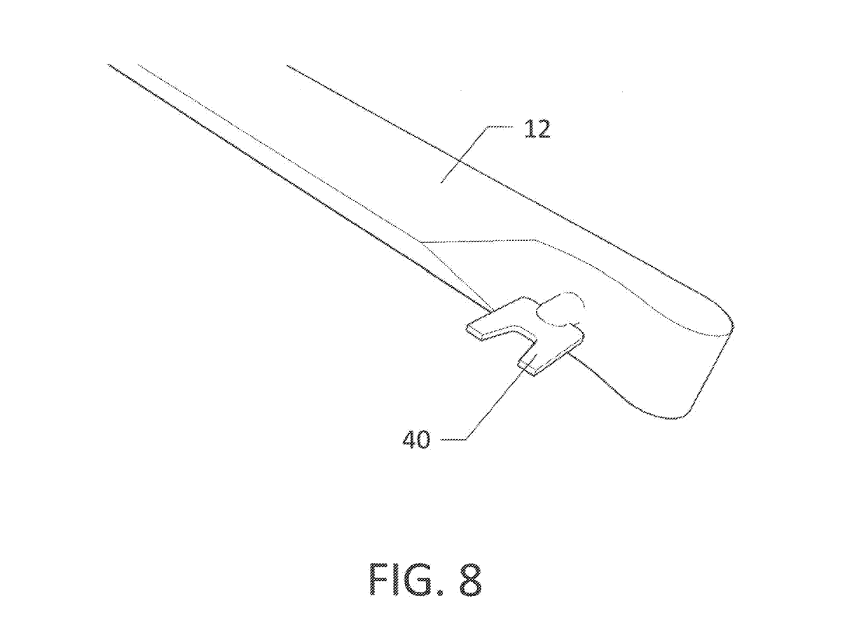

The illustration in FIG. 7 and FIG. 8 portrays an alternate embodiment of an alternate gripping member 34 and an alternate slitting member 40, respectively. In FIG. 7 alternate gripping member 34 is in a horseshoe shape which still allows for a central void 38. Gripping surface 36 is preferably textured such that the snack bag is held securely as the puncturing of the bag occurs. In FIG. 8 alternate slitting member 40 is shown with two prongs as opposed to three. Alternate slitting member 40 still has a sharpened or pointed surface in order to puncture the snack bag.

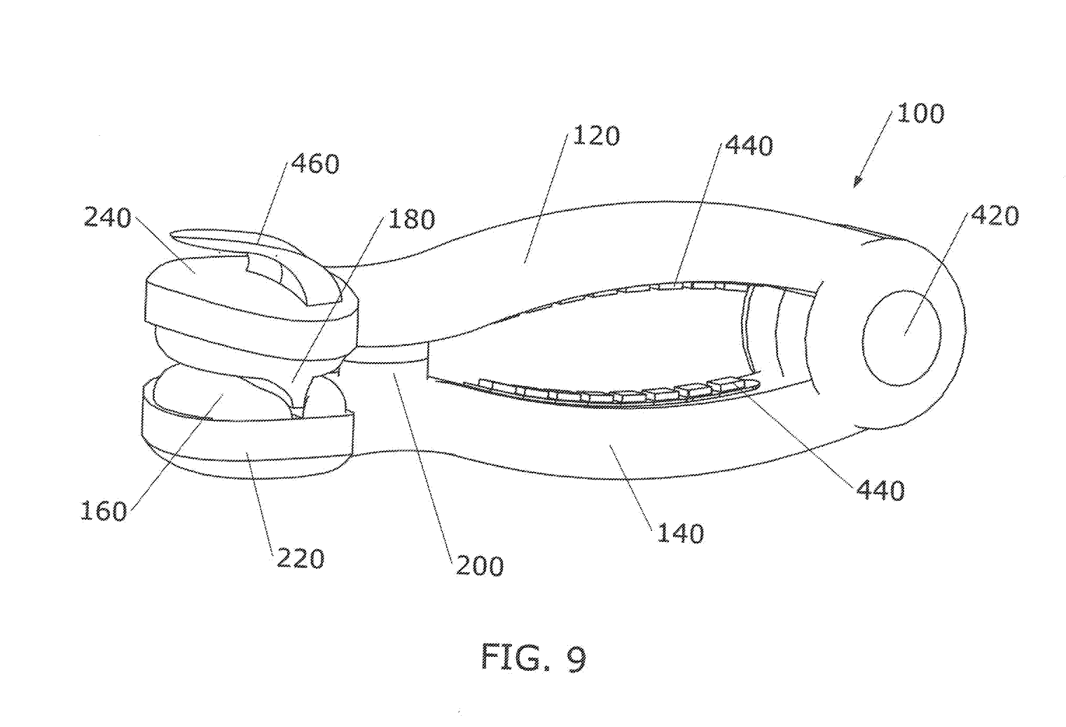

FIG. 9 illustrates the invention in the present embodiment. The device 100 has two arms 120, 140, each having a first end and a second end. The first end of first arm 120 and second arm 140 are connected together by any known means at connector 420 which allow first arm 120 and second arm 130 to pivot together and apart. For example, a bolt secured by a nut or a rivet which secures first arm 120 to second arm 140 can be used. However, any known method of creating a pivoting joint can be used. First arm 120 and second arm 140 have an interior surface and an exterior surface and are curved in design so that the user can easily grip the device. The user's hand can tit easily around the exterior surface of each arm 120, 140 for use.

The second end of first arm 120 and second arm 140 include end caps 240, 220. End cap 240 of first arm 120 includes a gripping member 180. End cap 220 of second arm 130 includes a slitting member 140. Gripping member 180 is capable of holding a snack bag or other object steady as slitting member punctures the object. Gripping member 180 and slitting member 140 meet when arms 120, 140 are pushed together. First arm 120 and second arm 140 include an optional stop 200 to allow gripping member 180 and slitting member 140 to meet together correctly.

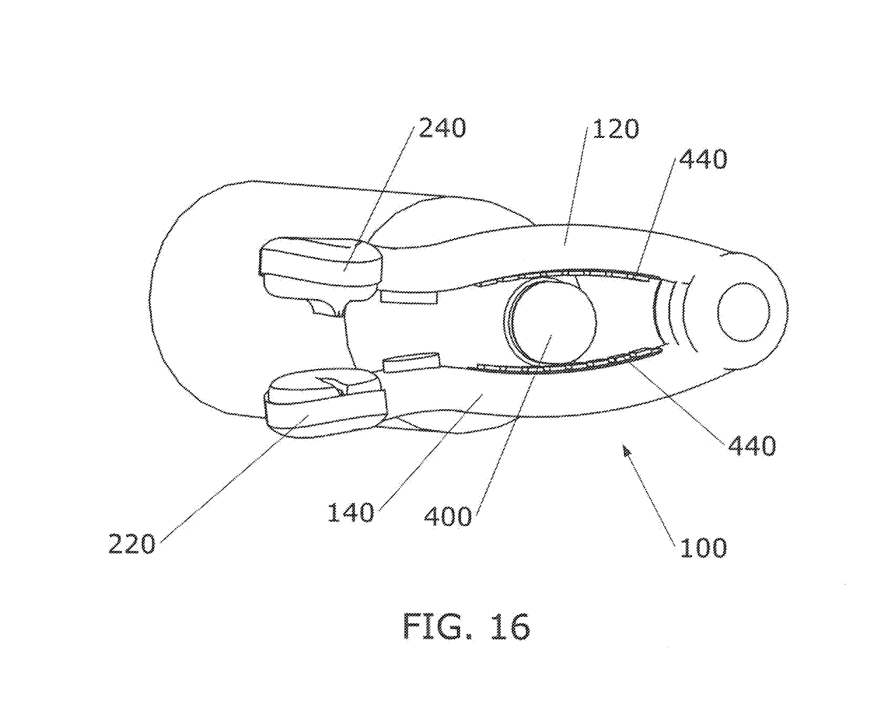

As illustrated, the device can optionally include a gripping surface 440 on the interior surface of either arm 120, 140 for opening bottles or jars. The gripping surface 440 can be serrated and made of rubber to improve the grip on the cap of the bottle or jar. The slight arc of the arms allows the gripping surface 440 to have a slight curve to it in order to allow the user to open varying sizes of bottles or jars. To open a bottle or jar the user can press the two arms 120, 140 together forming a tight partially closed circle around cap 400 such that the gripping surface 440 is applied to cap 400 of a bottle or jar, as illustrated in FIG. 16. Device 100 is shown opening bottle cap 400. In order to open cap 400 the user turns the device and continues to press device 100 closed while holding the bottle or jar in one place.

An optional top opener 460 can also be included for opening a mechanism such as the stay-on-tab of a soda can. Top opener 460 is preferably integral with end cap 240 of first arm 120. As illustrated, top opener 460 is slightly wedge shaped such that as the user slides the top opener 460 under the stay-on-tab of a soda can the stay-on-tab is lifted upward away from the can.

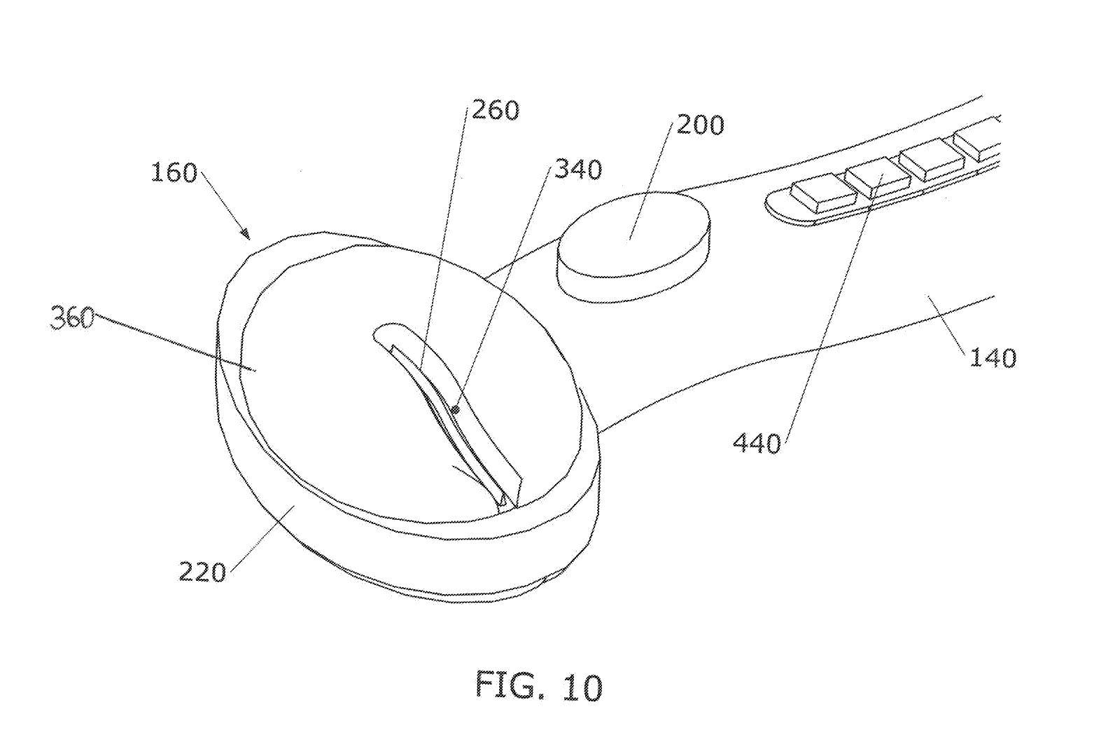

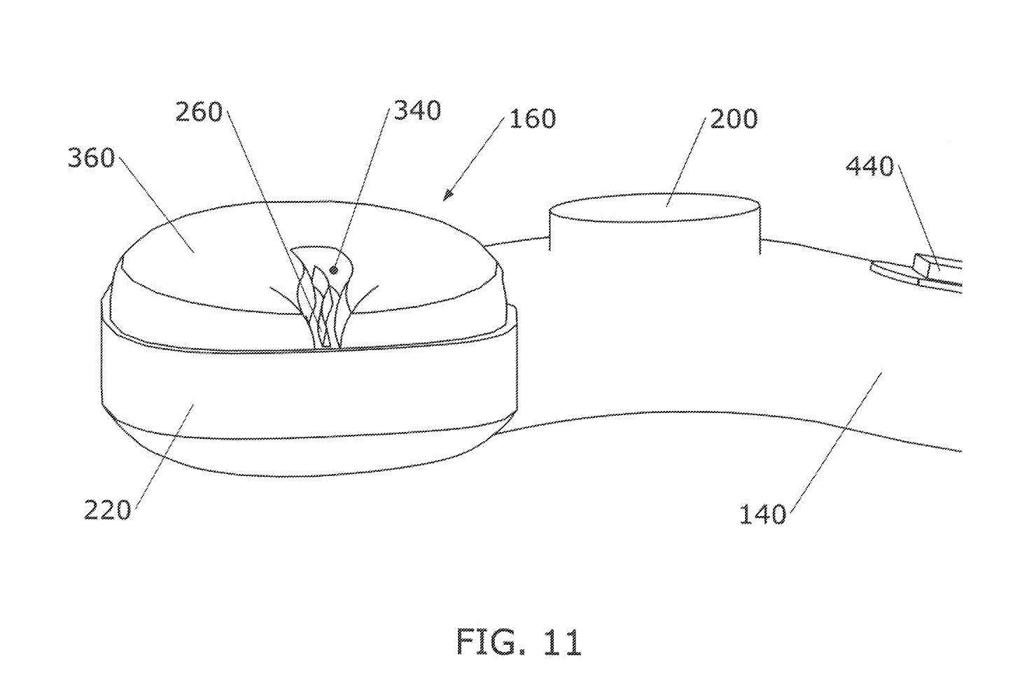

FIG. 10 illustrates the slitting member 160. Slitting member 160 is attached to end cap 220. Slitting member 160 includes blade 260, surface 360 and crevice 340. Surface 360 is curved and smooth along the slitting edge of blade 260. Slitter surface 360 forms crevice 340 which surrounds blade 260 such that a user can contact slitter surface 360 without contacting blade 260. A close up view is shown of slitting member 160 in FIG. 11. The reader will appreciate that the top edge of blade 260 is still within crevice 340. Blade 260 can be any shape. In one embodiments blade 260 is a flat, circular standard blade that is nested within end cap 220.

Blade 260 extends into crevice 340 from beneath slitter surface 360. Slitter surface 360 curves about the contour of blade 260 such that blade 260 does not extend outward beyond slitter surface 360. Crevice 340 can be located along any area of the slitter surface 360 and can be in any shape. However, crevice 340 must be positioned to prevent blade 260 from being exposed.

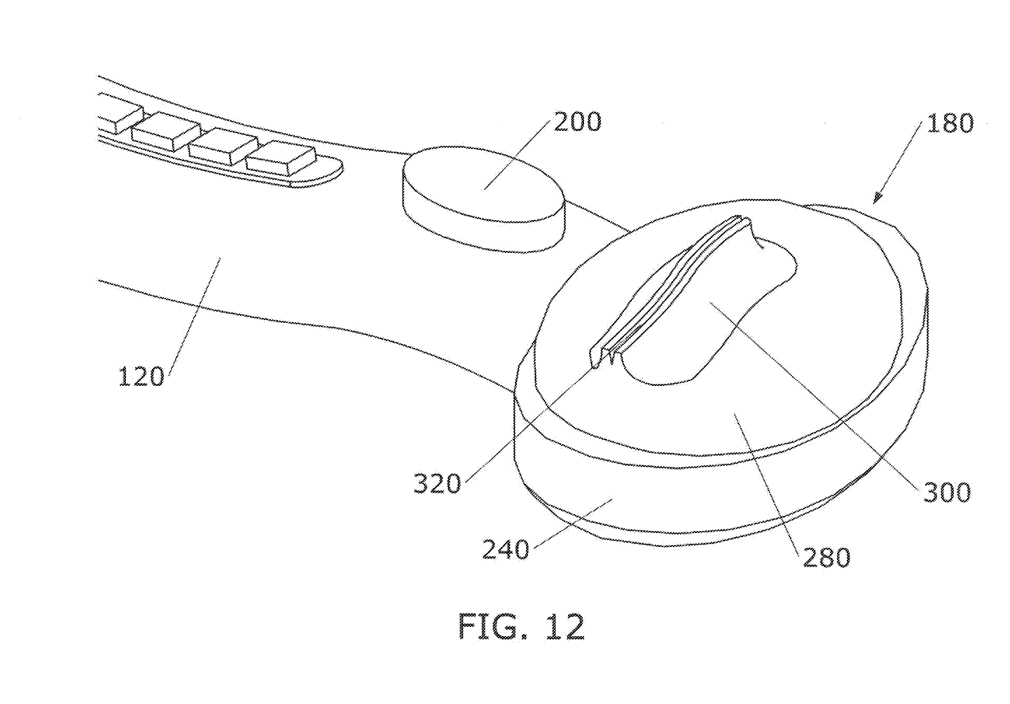

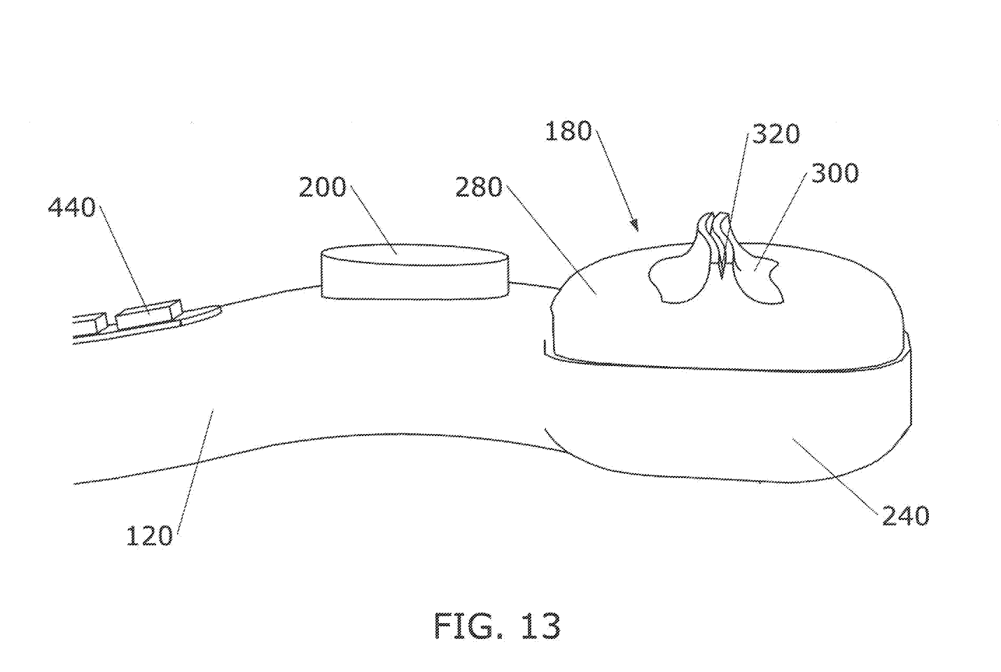

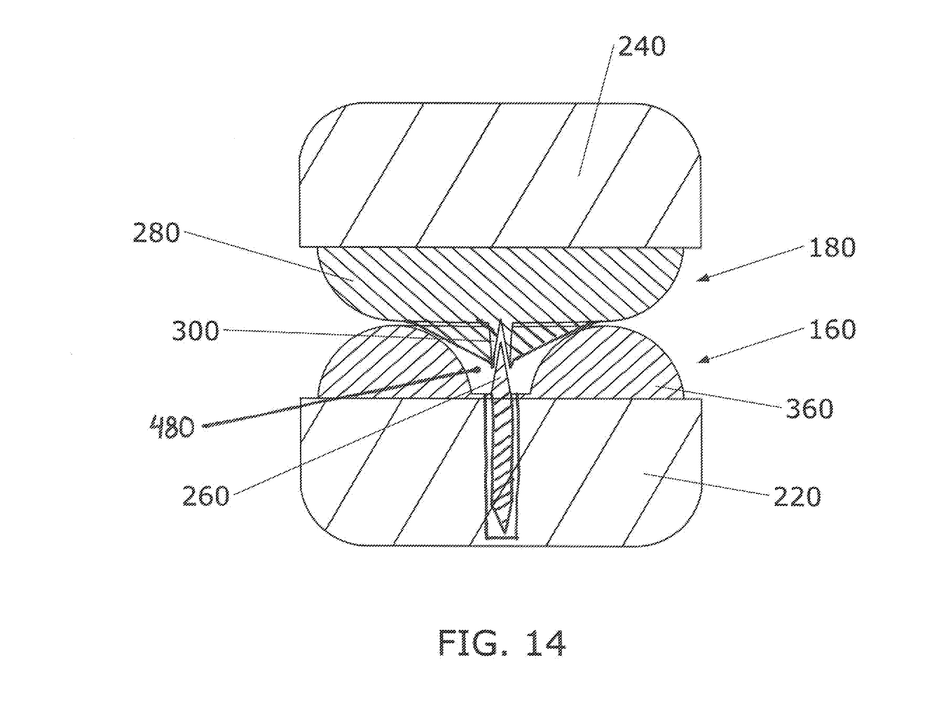

A view of gripping member 180 is shown in FIG. 12. Gripping member 180 has a surface 280, a raised portion 300 and a channel 320. Surface 280 is preferably smooth and integral with raised portion 300. Raised portion 300 lifts away from surface 280 and includes channel 320. FIG. 13 shows a close up view of gripping member 180. Channel 320 is shown as curved for purpose of illustration, however channel 320 can be any shape or size. However, channel 320 must follow the contour of blade 260 included in slitting member 160. Therefore, when gripping member 180 and slitting member 160 meet together, as illustrated in a cross-section view in FIG. 14, blade 260 of slitting member 160 enters channel 320 of raised portion 300 but does not come into contact with raised portion 300. The contact between surface 280 and raised portion 300 of gripping member 180 and surface 360 of slitting member 160 allows for a continuous gap 480 formed within channel 320 and crevice 340, even when device 100 is fully closed (gap 480 is illustrated in FIG. 14). In the embodiment with a curved blade, surface 360 of slitting member 160 follows the continuous radial contour of the circular edge of blade 260 without ever coming into contact with blade 260.

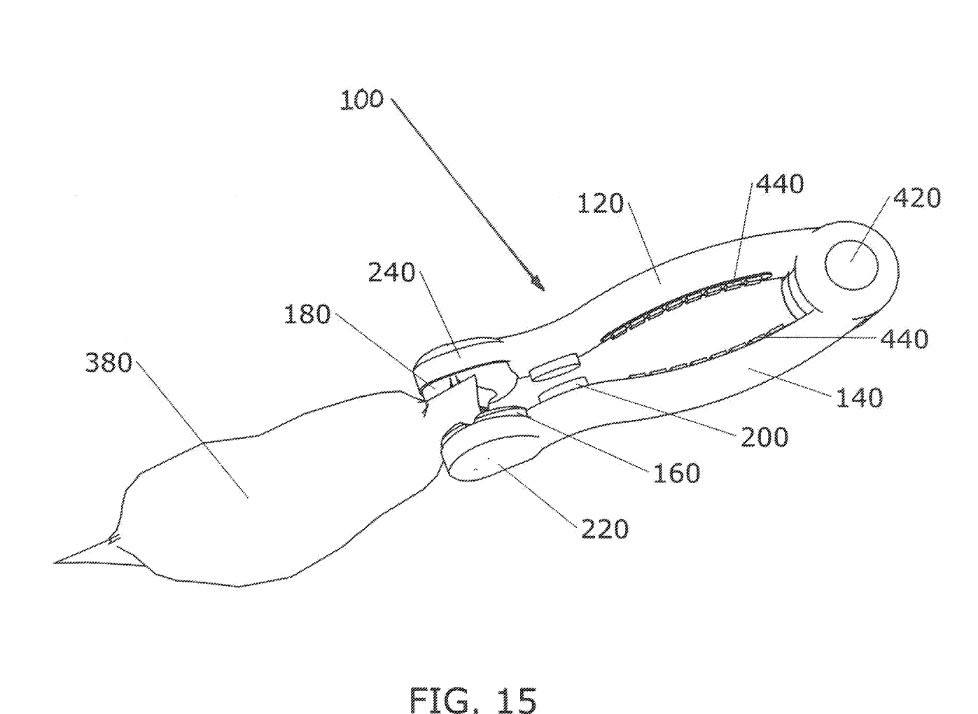

The gap 480 allows the bag (or object) being cut to easily pass through along the bags length. Thus, the user can grip bag 380, as illustrated in FIG. 15, and pull device 100 along the length of bag 380. Bag 380 slides easily and smoothly through gap 480 created by device as slitting member 160 gently cuts the bag open. Gripping member 180 prevents bag 380 from escaping by pinching bag with the top of raised portion 300 into crevice 340 of slitting member 160. Again, an gap 480 is maintained such that bag 380 can slide easily through device 100 as blade 260 slices through the portion of bag 380 pushed into crevice 340 by raised portion 300 of gripping member 180.

The preceding description contains significant detail regarding the novel aspects of the present invention. It should not be construed, however, as limiting the scope of the invention but rather as providing illustrations of the preferred embodiments of the invention. As an example, the arms 120, 140 may not include gripping surface 440 and could be various different shapes. Thus, the scope of the invention should be fixed by the following claims, rather than by the examples given.

Having described my invention, I claim:

1. An opener device for assisting a user with opening a bag, comprising:
a. a first arm, having a first end, a second end, an interior surface and an exterior surface;
b. a second arm, having a first end and a second end, an interior surface and an exterior surface, wherein said first end of said first arm and said second end of said second arm are connected together;
c. a gripping member attached to said second end of said first arm, wherein said gripping member has a surface, a raised portion and a channel;
d. a slitting member attached to said second end of said second arm, wherein said slitting member has a surface, a crevice and a blade; and
e. wherein said gripping member and said slitting member meet together when said first arm and said second arm are pivoted together such that said blade of said slitting member is capable of piercing said bag.

2. The opener device as recited in claim 1, farther comprising:
a. an end cap on said second end of said first arm; and
b. an end cap on said first end of said second arm.

3. The opener device as recited in claim 2, wherein said gripping member is attached to said end cap of said first arm and said slitting member is attached to said end cap of said second arm.

4. The opener device as recited in claim 3, further comprising a top opener attached to said end cap of said first arm.

5. The opener device as recited in claim 1, wherein said first arm and said second arm further comprise a gripping surface attached to the interior surface of said first arm and said second arm.

6. The opener device, as recited in claim 1, wherein said first arm and said second arm are curved.

7. The opener device as recited in claim 1, further comprising a connector pivotably connecting said first end of said first arm to said first end of said second arm.

8. The opener device as recited in claim 1, wherein said first arm has a stop proximate said second end of said first arm and said second arm has a stop proximate said second end of said second arm.

9. The opener device as recited in claim 1, wherein said surface of said slitting member is smooth and forms a crevice around said blade such that said surface extends above said blade.

10. The opener device as recited in claim 1, wherein when said gripping member and said slitting member meet together in a closed position, said surface and said raised portion of said gripping member contact said surface of said slitting member forming a gap.

11. The opener device as recited in claim 9, wherein said blade enters said channel of said gripping member such that said blade is capable of slicing said bag.

12. An opener device for assisting a user with opening a bag having an open position and a closed position, comprising:
a. a first arm and a second arm pivotably connected together at a connector;
b. wherein said first arm has a first and second end and further comprises an end cap attached to a gripping member having a surface, a raised portion and a channel;
c. wherein said second arm has a first and second end and further comprises an end cap attached to a slitting member having a surface, a crevice and a blade; and
d. wherein when said device is in said closed position said raised portion of said gripping member contacts said surface of said slitting member and said blade of said slitting member enters said, channel of said gripping member such that said blade is capable of puncturing said bag.

13. The opener device as recited in claim 12, further comprising a top opener attached to said end cap of said first arm.

14. The opener device as recited in claim 13, wherein said first arm and said second arm further comprise a gripping surface attached to the interior surface of said first arm and said second arm.

15. The opener device as recited in claim 12, wherein said first arm and said second arm are curved.

16. The opener device as recited in claim 12, wherein said first arm has a stop proximate said second end of said first arm and said second arm has a stop proximate said second end of said second arm.

17. The opener device as recited in claim 12, wherein said surface of said slitting member is smooth and forms a crevice around said blade such that said surface extends above said blade and prevents blade from being exposed to said user.

18. The opener device as recited in claim 12, wherein when said gripping member and said slitting member meet together in said closed position, said surface and said raised portion of said gripping member contact said surface of said slitting member forming a gap.

19. An opener device for opening a bag, comprising
a. a first arm and a second arm pivotably connected together at a connector;
b. wherein said first arm further comprises an end cap attached to a gripping member having a surface, a raised portion and a channel;
c. wherein said second arm further comprises an end cap attached to a slitting member having a surface, a crevice and a blade; and
d. wherein said first arm and said second arm are capable of pivoting together such that said gripping member and said slitting member meet causing said blade of said slitting member to enter said channel of said gripping member.

20. The opener device as recited in claim 19, further comprising a top opener attached to said end cap of said first arm.
